(19) United States
(12) Patent Application Publication
(10) Pub. No.: US 2025/0342132 A1
(43) Pub. Date: Nov. 6, 2025

(54) APPARATUS AND METHOD FOR DETERMINISTIC INPUT/OUTPUT PERFORMANCE

(71) Applicant: Intel Corporation, Santa Clara, CA (US)

(72) Inventors: Aruni NELSON, Rocklin, CA (US); Robert L. VAUGHN, Portland, OR (US)

(21) Appl. No.: 19/273,240

(22) Filed: Jul. 18, 2025

(51) Int. Cl. G06F 13/40

(52) U.S. Cl. CPC G06F 13/4022

(57) ABSTRACT

Provided is an apparatus comprising interface circuitry, machine-readable instructions and processing circuitry to execute the machine-readable instructions. The machine-readable instructions include instructions to detect a connection of a peripheral device to an I/O connector of a plurality of I/O connectors connected to an SoC. The plurality of I/O connectors are configured to be coupled to a plurality of I/O controller ports of the SoC via a crossbar switch. The plurality of I/O controller ports are associated with an I/O performance level. At least two I/O controller ports have a different I/O performance level. The machine-readable instructions further include instructions to determine a target I/O controller port from the plurality of I/O controller ports for the peripheral device based on previous routing information for the peripheral device and to instruct the crossbar switch to electrically route the I/O connector to the determined target I/O controller port.

### BACKGROUND

Modern computing systems may rely on high-speed communication between processing components and peripheral devices to meet high performance demands in client and server platforms. These computing systems may expose a variety of input/output (I/O) connectors for interfacing with external devices such as storage drives, network adapters, accelerators, or user interfaces. The connectors may internally be routed to I/O controllers embedded within different regions of a system on chip (SoC), for example in areas traditionally referred to as a north die or a south die. Variations in internal architecture, trace lengths, controller locations, and resource allocation strategies may influence signal propagation latency, throughput consistency, and device-level responsiveness and degrade user-experience

### BRIEF DESCRIPTION OF THE FIGURES

Some examples of apparatuses and/or methods will be described in the following by way of example only, and with reference to the accompanying figures, in which

FIG. 1 illustrates a block diagram of an example of an apparatus;

FIG. 2 illustrates a flowchart of an example of a method;

FIG. 3 illustrates an example of a system implementing a static, hardwired mapping of I/O connectors to I/O controller ports in a SoC;

FIG. 4 illustrates an example of a system implementing of the disclosed technique, with flexibility in the mapping of I/O connectors to available I/O controller ports; and

FIG. 5 illustrates an example of a block diagram of an electronic apparatus incorporating at least one electronic assembly and/or method described herein.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

On some existing client and server platforms, input/output (I/O) ports may be exposed and electrically mapped either to an I/O controller residing in a south die (e.g., Platform Controller Hub, or PCH, also referred to as I/O die) or to an I/O controller residing in a CPU die (i.e., north die, located in closer physical proximity to system memory). Because the mapping of the I/O ports to their respective controllers might not be visible or known to the user, inconsistent performance may be observed depending on which I/O port is used for device connection. In particular, when an I/O device is connected to an I/O port that is mapped to a controller in the south die, the increased physical distance from system memory may lead to higher latency and reduced performance. This issue may be pronounced in server platforms that expose multiple Peripheral Component Interconnect Express (PCIe) slots. When a user connects an accelerator or another PCIe-based device to a slot serviced by a PCIe controller in the north die, improved performance is observed relative to a connection made to a slot serviced by a PCIe controller in the south die. This architectural asymmetry may present a challenge, including: (1) reduced device performance when connected to certain I/O ports; (2) observable variation in latency for the same device when connected to different I/O ports; and (3) lack of any indicator available to the user that distinguishes one I/O port from another in terms of performance, despite nominally identical capabilities such as supported features and interface bandwidth.

The disclosed technique may address these challenges by providing a system in which user experience is improved and performance consistency is achieved. The disclosed technique may enable the performance characteristics observed when an I/O device is connected to a high-performance port to be preserved or replicated even when the same I/O device is subsequently connected to a different I/O port. This may be achieved through dynamic routing, mapping memory-proximate controller ports preferentially, and optionally informing the user of available performance characteristics per port.

In previous examples, if a user has knowledge of the mapping between exposed input/output (I/O) ports and the die configuration of the system on chip, the user may actively choose to connect a peripheral device to an I/O port that is serviced by an I/O controller located in the north die of the SoC, which is in closer physical proximity to the system memory and may therefore offer higher performance. In some previous examples, user may elect to consistently connect a given I/O device to the same I/O port in order to maintain consistent performance across sessions. In some previous implementations, the exposed I/O ports may be labeled or otherwise annotated to indicate a relative performance level, such as distinguishing between high-performance and lower-performance ports, thereby enabling the user to make more informed connection decisions.

The proposed technique improves performance and routing consistency for peripheral device connections. The I/O Manager may be configured to cache a mapping between an I/O peripheral device and an I/O controller port previously used for the device. The I/O Manager, which may be implemented as a driver or firmware component, may be configured to transmit a message to an I/O connector controller, which may also be implemented in firmware. This message may comprise routing information or a routing hint for the I/O connection of the peripheral device. The disclosed technique may include a crossbar switch configured to enable routing of the I/O connection to an I/O controller that was previously used for the device. The I/O connector controller may be configured to program the crossbar logic to establish a high-performance I/O connection accordingly.

The proposed concept may be described using a generic interconnect architecture, however similar implementations may be applicable to specific technologies such as Peripheral Component Interconnect Express (PCIe), Universal Serial Bus (USB), or other comparable high-speed I/O interfaces.

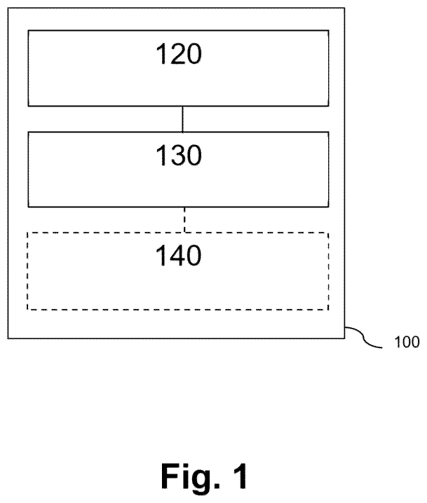

FIG. 1 illustrates a block diagram of an example of an apparatus 100 or device 100. The apparatus 100 comprises circuitry that is configured to provide the functionality of the apparatus 100. For example, the apparatus 100 of FIG. 1 comprises interface circuitry 120, processing circuitry 130 and (optional) storage circuitry 140. For example, the processing circuitry 130 may be coupled with the interface circuitry 120 and optionally with the storage circuitry 140.

For example, the processing circuitry 130 may be configured to provide the functionality of the apparatus 100, in conjunction with the interface circuitry 120. For example, the interface circuitry 120 is configured to exchange information, e.g., with other components inside or outside the apparatus 100 and the storage circuitry 140. Likewise, the device 100 may comprise means that is/are configured to provide the functionality of the device 100.

The components of the device 100 are defined as component means, which may correspond to, or implemented by, the respective structural components of the apparatus 100. For example, the device 100 of FIG. 1 comprises means for processing 130, which may correspond to or be implemented by the processing circuitry 130, means for communicating 120, which may correspond to or be implemented by the interface circuitry 120, and (optional) means for storing information 140, which may correspond to or be implemented by the storage circuitry 140. In the following, the functionality of the device 100 is illustrated with respect to the apparatus 100. Features described in connection with the apparatus 100 may thus likewise be applied to the corresponding device 100.

In general, the functionality of the processing circuitry 130 or means for processing 130 may be implemented by the processing circuitry 130 or means for processing 130 executing machine-readable instructions. Accordingly, any feature ascribed to the processing circuitry 130 or means for processing 130 may be defined by one or more instructions of a plurality of machine-readable instructions. The apparatus 100 or device 100 may comprise the machine-readable instructions, e.g., within the storage circuitry 140 or means for storing information 140.

The interface circuitry 120 or means for communicating 120 may correspond to one or more inputs and/or outputs for receiving and/or transmitting information, which may be in digital (bit) values according to a specified code, within a module, between modules or between modules of different entities. For example, the interface circuitry 120 or means for communicating 120 may comprise circuitry configured to receive and/or transmit information.

For example, the processing circuitry 130 or means for processing 130 may be implemented using one or more processing units, one or more processing devices, any means for processing, such as a processor, a computer or a programmable hardware component being operable with accordingly adapted software. In other words, the described function of the processing circuitry 130 or means for processing 130 may as well be implemented in software, which is then executed on one or more programmable hardware components. Such hardware components may comprise a general-purpose processor, a Digital Signal Processor (DSP), a micro-controller, etc.

For example, the storage circuitry 140 or means for storing information 140 may comprise at least one element of the group of a computer readable storage medium, such as a magnetic or optical storage medium, e.g., a hard disk drive, a flash memory, Floppy-Disk, Random Access Memory (RAM), Read Only Memory (ROM), Programmable Read Only Memory (PROM), Erasable Programmable Read Only Memory (EPROM), an Electronically Erasable Programmable Read Only Memory (EEPROM), or a network storage.

The processing circuitry 130 is configured to detect a connection of a peripheral device to an input/output (I/O), connector of a plurality of I/O connectors connected to a system on chip (SoC). The plurality of I/O connectors are configured to be coupled to a plurality of I/O controller ports of the SoC via a crossbar switch.

In some examples, the apparatus 100 may further comprise a system on chip (SoC). In some examples, the apparatus 100 may be part of the SoC. For example, the SoC may be an integrated circuit in which multiple functional components of a computing architecture are implemented on a single semiconductor substrate. A SoC may include processing elements, interface controllers, memory controllers, I/O controller ports, and other subsystems, enabling the execution of complex computing operations without the need for multiple discrete chips. The SoC may comprise a combination of CPUs, GPUs, hardware accelerators, memory interfaces, security engines, and peripheral I/O controllers. Each of these components may be interconnected via internal communication fabrics or buses and may share access to system memory. In some examples, the system on chip may include a crossbar switch to enable dynamic routing between multiple input/output connectors and internal I/O controller ports. The SoC may be subdivided into multiple physical or logical regions, such as a north die containing CPU cores and high-speed I/O ports, and a south die including auxiliary interfaces, storage controllers, or legacy I/O ports. The internal architecture of the system on chip may directly influence the I/O performance level of individual ports due to differences in trace lengths, memory proximity, or bandwidth availability. In some examples, both the north die and south die may have separate I/O controllers supporting same bandwidth but their distance from the system memory and the memory controller may differ based on the location of the I/O controllers.

For example, the SoC may be integrated within the apparatus 100 and may implement, for example, at least part of the interface circuitry 120, the processing circuitry 130, and/or optionally the storage circuitry 140. In some examples, the apparatus 100 may be part of the SoC, for example of an IO firmware manager of the SoC. The SoC may comprise the plurality of I/O controller ports (see below). In some examples, the SoC may be implemented as a discrete module that is operatively connected to the apparatus 100 but may be manufactured or packaged separately. The SoC may be electrically and logically coupled to the interface circuitry 120 and the processing circuitry 130 of the apparatus 100 via high-speed interconnects or board-level buses.

For example, an I/O connector may be a physical interface connected to the SoC. The SoC may be physically mounted on and/or electrically connected to a motherboard or circuit board motherboard, which may provide structural support and interconnects the SoC with other components. The plurality of I/O connectors may be connected to the motherboard. The plurality of I/O connectors may be configured to receive and transmit electrical signals to and from a peripheral device. The plurality of I/O connectors may be electrically coupled to the SoC through one or more signal traces, or via a switching component such as the crossbar switch. The plurality of I/O connectors may provide the mechanical and electrical interface through which a peripheral device communicates with the SoC and may serve as the point of signal ingress and egress for all data exchanged between the peripheral device and components of the SoC. In some examples, the apparatus 100 may further comprise the plurality of I/O connectors.

For example, an I/O controller may be a circuit integrated within the SoC. For example, the I/O controller may be part of the apparatus 100 or may be connected to the apparatus 100. The I/O controller may be configured to manage protocol-level communication with one or more peripheral devices connected via the I/O output connectors. The I/O controller may reside within the SoC, and its physical location may affect signal propagation latency and overall input/output performance. For example, the I/O controller may be located on a north die of the system on chip or a south die of the system on chip. For example, the north die may integrate a processor-side I/O controller that is located physically closer to a central processing circuitry and memory resources of the SoC, thereby offering lower signal latency and higher throughput for high-performance devices. The south die may integrate a chipset-side I/O controller that services peripheral connections of lower bandwidth or latency sensitivity, such as legacy I/O interfaces. The SoC may comprise a plurality of I/O controllers, for example, one controller integrated on the north die and one controller integrated on the south die.

An I/O controller may be configured to be specialized or multifunctional, and may be capable of supporting simultaneous communication across multiple protocols and peripheral types. For example, a processor-side I/O controller on the north die may expose multiple PCIe ports, while a chipset-side input/output controller on the south die may handle USB, SATA, or Ethernet communication via its own set of ports.

An I/O controller may manage and expose one or more I/O controller ports that serve as its external communication interfaces. Each I/O controller port may be controlled by one I/O controller to implement electrical signaling, protocol logic, and data exchange with connected peripheral devices. The I/O controller may configure, monitor, and coordinate the operation of its ports, including link establishment, error handling, and bandwidth allocation. The I/O controller and its corresponding I/O controller ports may be located on the same die of the SoC, such that the physical placement of the controller may determine the location of its ports. For example, a processor-side I/O controller on the north die may expose high-speed ports on the north die, while a chipset-side I/O controller on the south die may expose ports intended for general I/O functions on the south die or may have a I/O controller similar to the one in the north die.

For example, an I/O controller port may be a dedicated communication interface associated with an I/O controller, configured to serve as a termination point for a routed signal path originating from an I/O connector. An I/O controller port may include transceiver circuitry, line encoding/decoding logic, and protocol-specific link management hardware. The I/O controller port may reside within a specific region of the SoC, such as a north die or south die. Multiple V/O controller ports may be exposed by a single I/O controller and may correspond to different types or speeds of interfaces. I/O ports may differ in physical trace length to memory or other components, leading to measurable differences in signal propagation latency.

For example, a crossbar switch may be a reconfigurable hardware interconnect fabric that allows selective, programmable routing of electrical signal paths between the plurality of I/O connectors and the plurality of I/O controller ports. The crossbar switch may be implemented as a grid-like matrix of switches, supporting flexible one-to-one mapping of connectors to controller ports under software or firmware control. The crossbar switch may be physically located between the input/output connectors and the system on chip and may be controlled by processing circuitry or an I/O connector controller to establish or update connections. Internally, the crossbar switch may implement N×M routing logic, where each of plurality of N I/O connectors may be routed to one of the plurality of M I/O controller ports, based on conditions such as historical usage, signal propagation latency, device compatibility, or available bandwidth. The use of the crossbar switch may allow the apparatus 100 to dynamically determine the most suitable internal controller port for any newly connected peripheral device, instead of relying on static trace connections. The crossbar switch may support protocol-agnostic routing or may include protocol-aware switch logic optimized for high-speed signaling. In some examples, the apparatus 100 may further comprise the crossbar switch. For example, the crossbar switch may be used to route a DisplayPort connector to a DisplayPort controller with lower latency and higher performance based on the device type and the port availability. Similarly, the crossbar switch may also be used to route a thunderbolt peripheral connection to a Thunderbolt port of a Thunderbolt controller residing in the north die or the south die, based on the device type and port availability.

For example, a peripheral device may be an external component configured to interact with a the SoC, or the computing apparatus including the SoC via the I/O connector and communicate with the SoC through an associated I/O controller port. The peripheral device may comprise functional circuitry for data input, output, processing, storage, display, or communication, and may operate using standardized communication protocols.

The peripheral device may be for example, input peripherals such as keyboards, game controllers, or biometric readers; storage peripherals such as external hard drives, flash memory sticks, or network-attached storage units; output peripherals such as printers, monitors, or speakers. For example, the peripheral device may be a hybrid or intelligent device such as external graphics processing units (eGPUs), high-speed data acquisition modules, or virtual reality headsets. The performance characteristics and protocol requirements of each peripheral device may influence the apparatus's determination of an I/O controller port via the crossbar switch. Some peripheral devices may support tunneling of multiple protocols (e.g., Thunderbolt docking stations), further affecting routing decisions.

As an example, the peripheral device may be a mixed-protocol external workstation dock that includes DisplayPort video output, Ethernet networking, and USB input devices, all of which connect through a single USB4 or Thunderbolt connector to the apparatus and are internally routed to multiple controller ports within the system on chip.

The connection of a peripheral device to the I/O connector may be detected by the processing circuitry 130 monitoring the electrical state changes or link initialization signals on the I/O connector to detect when a peripheral device is physically connected. In some examples, the I/O controller associated with the connected I/O controller port may detect the connection based on protocol-specific events, such as device enumeration, power negotiation, or link training sequences and may notify the processing circuitry 130.

In some examples, the processing circuitry 130 may be further configured to receive a message by an I/O connector controller. The I/O connector controller may be connected to the plurality of I/O connectors. The message may comprise information that the connection of the peripheral device to the I/O connector is detected. For example, the I/O connector controller may be a hardware or firmware-based component connected to the plurality of I/O connectors. For example, the I/O connector controller may be part of the apparatus 100 and may be implemented by the processing circuitry 130 or it may be a separate entity. The I/O connector controller may be responsible for monitoring the physical state of the I/O connectors, such as detecting changes in voltage levels, sensing pull-up resistors, or interpreting device enumeration sequences, to determine whether a peripheral device has been physically plugged in. Once a connection event is detected, the I/O connector controller may generate and transmit a message to the processing circuitry 130, conveying the connection status and possibly additional metadata, such as the I/O connector identifier or characteristics of the peripheral device.

The plurality of I/O controller ports are associated with an I/O performance level. At least two of the plurality of I/O controller ports have a different I/O performance level. The I/O performance level may describe the ability of the I/O controller port to transmit and receive data in absolute metrics and/or relative to other ports. For example, the performance level may be described based on factors such as latency, bandwidth, throughput, or proximity to memory or processing components. The I/O performance level may be a measure used to differentiate I/O ports with respect to how efficiently they support data communication with a connected peripheral device. For example, an I/O controller port located on the SoC die physically closer to the memory of the SoC may have a lower signal propagation latency and thus a higher I/O performance level than a port located farther away. Different I/O controller ports may therefore offer varying levels of performance, and these differences may influence routing decisions to optimize system responsiveness or resource usage.

In some examples, the I/O performance level may be based on a signal propagation latency between communication endpoints corresponding to the I/O system. In some examples, the I/O performance level comprises a signal propagation latency between the I/O connector (connector to which a peripheral device is connected and a memory) and a memory of the SoC, and a higher I/O performance level corresponds to a lower propagation latency. In some examples, the I/O performance level may comprise a latency measure between the I/O controller associated with the I/O connector and the memory of the SoC. A higher I/O performance level may correspond to a lower signal propagation latency, indicating that signals travel more quickly between the relevant components, resulting in faster data access and reduced response times.

The overall signal path that affects propagation latency may extend from the peripheral device to the memory of the SoC. This may include all intermediate stages such as the I/O connector, the motherboard traces, the crossbar switch, the I/O controller port, the I/O controller, and the internal interconnects to memory. Accordingly, the I/O performance level associated with the I/O controller port may reflect a composite measure of signal latency through this entire path, and the processing circuitry 130 may evaluate these characteristics to determine how to route a given peripheral device for optimal communication performance In some examples, the signal propagation latency may be based on at least one of the following: a physical trace length of a signal path between the I/O connector and the I/O controller port, a distance between the I/O controller and a memory of the SoC or a location of the I/O controller, wherein the location of the I/O controller is either on a north die or a south die of the SoC.

The physical trace length may refer to the conductive path formed on the motherboard that electrically connects the I/O connector, where the peripheral device is physically connected, to the I/O controller port of the SoC. A longer trace length may result in increased signal delay, resistance, and potential signal degradation, whereas a shorter trace may reduce latency and improve signal quality. For example, an I/O connector located at the edge of a motherboard and connected to its I/O controller port through a trace of 15 centimeters may exhibit a higher latency than an I/O connector routed through a 4-centimeter trace positioned closer to the SoC package.

The distance between the I/O controller associated with the I/O controller port and the memory of the SoC may influence how quickly data can be transmitted between the I/O controller and the memory subsystem of the SoC, such as a dynamic random-access memory (DRAM) interface or memory controller. A shorter physical or architectural distance may allow faster memory transactions, contributing to a higher I/O performance level. For example, an I/O controller implemented on a north die of the SoC that is positioned adjacent to the memory controller may support lower-latency memory access than an I/O controller implemented on a south die that communicates with memory through a more indirect interconnect.

The location of the I/O controller itself may be either on a north die or a south die of the SoC. The physical die on which the I/O controller resides may affect both internal data routing and proximity to other key SoC components such as processing circuitry or memory. For example, the north die of the SoC may include high-performance I/O controllers positioned near central processing circuitry and memory interfaces, thereby enabling low-latency communication paths for time-critical peripheral devices such as solid-state drives connected via Peripheral Component Interconnect Express (PCIe). In contrast, the south die may include PCIe Controllers which may tolerate greater latency due to their increased distance from the system memory and the memory controller.

In some examples, the SoC may expose multiple I/O connectors of the same type, such as several Peripheral Component Interconnect Express (PCI Express or PCIe) or Thunderbolt ports. The same connectors may have different performances arising from differences in the internal routing of these connectors to distinct I/O controllers residing in the north die while others may be located in the south die. For example multiple PCIe connectors may provide different performance based on whether the PCIe controller is in the north or south die and similarly multiple Thunderbolt connectors may provide different performances based on which connectors are connected to thunderbolt controllers in the north or the south die.

In some examples, data structure may be maintained representing an N x M matrix, corresponding to the N×M routing logic of the crossbar, where each entry corresponds to a potential routing path between one of the plurality of N I/O connectors and one of the plurality of M I/O controller ports. Each entry in this matrix may be associated with a performance level that reflects the communication efficiency or suitability of the corresponding connector-port path. The matrix may be stored in firmware or software, for example in the storage circuitry 140 of the apparatus 100, and may be accessible to the processing circuitry 130. The performance levels entries in the matrix may be pre-characterized during system design, dynamically measured during operation, or updated based on historical telemetry data from previous peripheral connections. Not all connector-port pairs may be associated with a defined performance level. In some examples, the matrix may contain entries only for compatible or electrically routable paths, while in other configurations, the matrix may cover the full N×M space with varying degrees of performance. For example, a USB-C connector on the front panel of the apparatus may have a high performance level when routed to a USB4 controller port on the north die due to low latency and proximity, and a lower performance level when routed to a legacy USB 3.0 controller port on the south die due to increased propagation delay.

The processing circuitry 130 is configured to determine a target I/O controller port from the plurality of I/O controller ports for the peripheral device based on previous routing information for the peripheral device. In some examples, the routing information for a peripheral device may represent stored data that associates the peripheral device a specific I/O controller port used in one or more previous connection sessions. The routing information may comprise an identifier of the peripheral device, such as a unique device ID, vendor and product code, or class of device, as well as a record of the previously assigned I/O controller port, the I/O connector involved in the routing, and/or performance characteristics observed during the session. The routing information may also reflect user-defined preferences or system policies, such as fixed port bindings, exclusion rules, or connection order history. The routing information may be stored storage circuitry 140, and may be accessible to the processing circuitry 130 at runtime. Based on the routing information, the processing circuitry 130 may determine the target I/O controller port by comparing the currently detected peripheral device against previously stored routing entries. If a matching entry is found, that is the peripheral device was previously connected to the SoC, the same I/O controller port may be selected again as the target port. This may ensure consistent behavior, predictable latency, or compatibility with retained peripheral device state. For example, if a Thunderbolt hard drive was previously connected to a front panel connector and routed through a high-speed I/O controller port on the north die, the same routing may be re-established automatically upon re-connection, provided the port is available.

In some examples, the processing circuitry 130 may be further configured to store the routing information between the peripheral device and the determined target port upon a first connection of the peripheral device. The routing information may capture a binding or association between the connected peripheral device and the I/O controller port that has been selected for handling the connection. This stored association may form the basis for routing decisions during subsequent connections of the same peripheral device. The routing information may include an identifier of the determined target I/O controller port, the I/O connector through which the device was connected, and/or metadata such as connection time, protocol type, or observed communication characteristics. By storing this routing information on the first connection, consistent and repeatable routing behavior for the peripheral device may be enabled. For example, if a high-speed USB4 device is connected through a particular front-panel connector and routed to an I/O controller port on the north die with superior I/O performance level, the same routing path may be reused on future connections of the same device. This may improve user experience by providing stable data rates, optimizing enumeration, or preserving protocol-specific state across sessions.

In some examples, the processing circuitry 130 may be further configured to determine the target I/O controller port by selecting an available port with the best I/O performance level if no previous routing information for the peripheral device is available. In some examples, the availability of an I/O controller port may refer to whether the port is currently unoccupied and capable of being dynamically assigned to an I/O connector via the crossbar switch. A port may be considered available if it is not actively routed to another peripheral device, not reserved by system policy, and not disabled due to hardware faults or power management constraints. Availability may also depend on protocol compatibility or bandwidth allocation, ensuring that the port can properly support the communication requirements of the newly connected peripheral device.

If the processing circuitry 130 does not find previously stored routing information for the connected peripheral device, such as in the case of a first-time connection, the processing circuitry 130 may apply the default selection policy to determine the most suitable I/O controller port. This default strategy may involve evaluating the available I/O controller ports based on their associated I/O performance levels and selecting the port with the best (e.g. the highest) I/O performance level that is currently available for routing.

Selecting the best I/O performance level may ensure that the peripheral device is routed to a port that is likely to deliver the highest throughput or the most responsive data transfer behavior, especially for high-performance peripherals such as external solid-state drives, high-resolution cameras, or docking stations with multiple downstream endpoints. This behavior may be implemented by scanning the stored matrix of available I/O controller ports, filtering out ports that are currently occupied or reserved, and then selecting the one offering the highest available performance.

The processing circuitry 130 is configured to instruct the crossbar switch to electrically route the I/O connector to the determined target I/O controller port. The crossbar switch may include a reconfigurable matrix of electrical switches or multiplexers arranged in a grid, where each row corresponds to an I/O connector and each column corresponds to an I/O controller port. For example, each intersection in the grid may contain an electrically actuated switch, such as a transmission gate, tri-state buffer, or analog switch, that may be selectively enabled or disabled. When instructed by the processing circuitry 130, the crossbar switch may activate the corresponding intersection to form a conductive signal path between the connector and the controller port, effectively routing data signals, control lines, and reference voltages between the two endpoints.

The electrical routing may support bidirectional signaling and maintain signal integrity through impedance matching, signal buffering, or isolation mechanisms. The reconfiguration may occur during device enumeration, hot-plug detection, or dynamic reallocation scenarios and may take place within microseconds, allowing rapid adaptation to changing peripheral configurations. For example, when a USB device is connected to a front-panel I/O connector, and the target I/O controller port is identified as a high-speed USB4 controller on the north die, the processing circuitry 130 may instruct the crossbar switch to activate the corresponding switch cell, thereby creating a direct electrical link between that specific I/O connector and the chosen port.

In some examples, the processing circuitry 130 may be configured to generate a control message, command signal, or programming instruction that configures the crossbar switch to establish the specific electrical connection between the selected I/O connector and the determined target I/O controller port. This instruction may be conveyed via a dedicated management interface, such as a control bus, register file, or programmable logic interface accessible to the crossbar switch.

In some examples, the processing circuitry 130 may be further configured to transmit a message to an I/O connector controller. The I/O connector controller may be configured to program the crossbar switch. The message comprising information regarding the routing of the I/O connector to the determined target I/O controller port. The I/O connector controller may manage configuration and control operations related to the plurality of I/O connectors, and may act as an intermediary between the processing circuitry 130 and the hardware-crossbar switch.

In some examples, the message comprises at least one of a target I/O port identifier, a peripheral device identifier, or a peripheral device type. The target I/O port identifier may uniquely identify the I/O controller port, among the plurality of available I/O controller ports, that has been selected as the destination for the peripheral device's signal path. This identifier may correspond to a physical port location, a port index, or a protocol-specific destination endpoint. The peripheral device identifier may uniquely represent the device that has been connected to the I/O connector. This identifier may be derived from device-specific information such as a vendor ID, product ID, serial number, or class code, and may be used by the I/O connector controller to correlate routing entries or apply device-specific configuration rules. The peripheral device type may indicate a general classification of the connected device, such as mass storage device, display output device, audio interface, network adapter, or human interface device. Inclusion of the device type in the message may allow the I/O connector controller to apply protocol-or class-specific routing logic, or to select among multiple compatible controller ports that differ in performance or capability.

Upon receiving this message, the I/O connector controller may interpret the routing information and issue low-level configuration commands or register writes to the crossbar switch, thereby causing the switch to activate a specific path that electrically couples the identified I/O connector with the selected I/O controller port.

The above-described technique allows peripheral devices to be routed to internal I/O controller ports in a manner that may be performance-optimized and deterministic. By maintaining and reusing routing information from previous connections, the technique enables consistent re-routing of the same peripheral device to the same I/O controller port during subsequent sessions. This deterministic behavior contributes to an improved user experience, as users can rely on stable, predictable behavior from their connected devices, avoiding unnecessary reconfiguration, redundant enumeration, or performance shifts across reboots or reconnections. In particular, devices such as external boot drives, hardware security keys, or protocol-sensitive interfaces benefit from consistent port assignment, which also reduces errors and system management complexity.

The technique provides a mechanism to automatically select the optimal I/O controller port based on I/O performance level in cases where no prior routing information is available. This ensures that newly connected peripheral devices, such as external storage, displays, or expansion hubs, are routed to the most suitable port, considering factors like trace length, controller proximity to memory, or die location. The combination of deterministic routing for known devices and performance-based selection for new devices may enable both continuity and efficiency, offering a system architecture that maximizes throughput while providing users with a consistent and dependable interaction model.

The above-described technique may enable a deterministic interconnect performance, which ensures that peripheral devices are routed to internal I/O controller ports in a consistent and predictable manner across repeated connections. By maintaining and reusing routing information from prior sessions, the technique enables stable re-routing of the same peripheral device to the same I/O controller port, minimizing variation in performance and device initialization. This determinism may reduce the need for reconfiguration or redundant enumeration and contributes to a more reliable and streamlined user experience, particularly for sensitive devices such as boot drives, security keys, or protocol-specific peripherals. Further, the technique may support automatic selection of the optimal I/O controller port when no prior routing data is available, thereby maintaining performance optimization even during first-time connections. Its deterministic interconnect performance may thus combine continuity for known devices with efficient resource allocation for new ones, aligning device routing with factors such as trace length, die location, and memory proximity. This consistent behavior may simplify system management while maximizing throughput and interface reliability.

In some examples, the processing circuitry 130 may be further configured to observe performance characteristics of the peripheral device via port telemetry. This means that the processing circuitry 130 may monitor real-time or historical usage data that is collected at the I/O controller port level during operation. Port telemetry may comprise metrics such as data throughput, latency, protocol activity, error rates, or duration of active transfer. These metrics may be evaluated by the processing circuitry 130 to assess how intensively a peripheral device uses the assigned port and whether the performance capacity of the currently connected port is fully utilized.

In some examples, the processing circuitry may be further configured to determine, based on the observed performance characteristics, that a peripheral device's performance requirement is met by a lower-performance I/O controller port. The processing circuitry 130 may be further configured to update the stored routing information for the peripheral device, wherein the lower-performance I/O controller port is stored as the updated target port. This dynamic adjustment may support more efficient utilization of high-performance resources, freeing them for devices that require greater throughput or lower latency. The updated routing information may ensure that future connections of the same peripheral will be directed to the newly selected port, optimizing overall port allocation across the apparatus. For example, if telemetry shows that a printer or keyboard connected to a high-speed controller port consistently operates far below the bandwidth threshold of the port, the processing circuitry 130 may mark a lower-speed controller port as the new target port for subsequent connections.

In some examples, the processing circuitry 130 may be further configured to determine the target I/O controller port by selecting an available port with a next highest I/O performance level if the I/O controller port used in a previous connection is not available. If the port previously associated with a given peripheral device is currently unavailable, for example, due to being occupied, reserved, or disabled, the processing circuitry 130 may consult a predefined ranking of alternative ports ordered by decreasing I/O performance level and select the best-performing port that is currently available. The determination of the next best port may be guided by the stored matrix that maps the I/O performance levels between the I/O connector and the I/O controller port as described above. The processing circuitry 130 may evaluate this N×M matrix to identify the best available connection route from the current connector to the remaining controller ports. By doing so, it may be ensured that even in fallback conditions, the peripheral device is routed through a path that approximates the performance of the originally assigned port as closely as possible.

In some examples, determining the target I/O controller port may be based on an order in which a plurality of different peripheral devices are connected to the SoC. The order may be establishing a routing preference for subsequent connections of the peripheral devices. The processing circuitry 130 may observe the sequence in which multiple peripheral devices are connected during operation, such as during a boot sequence, docking process, or user-driven hot-plugging, and use this temporal order to guide routing decisions. The connection order may serve as an implicit prioritization rule, where earlier-connected devices are assigned higher-performance or preferred I/O controller ports. The processing circuitry 130 may store a mapping that reflects this sequence and treat it as a routing preference template for future sessions. For example, if a mass storage device is typically connected before a low-bandwidth input device, the storage device may consistently receive the higher-performance port. This order-based prioritization helps enforce fairness, supports deterministic reuse of high-performance ports, and ensures consistent system behavior across device reconnections.

In some examples, a first group of the I/O controller ports may be located on a north die of the Soc and a second group may be located on south die of the SoC. The target I/O controller port may be determined by selecting an I/O controller port from the same group that was used for a previous connection. For instance, if a peripheral device was previously routed to a port on the south die, and that specific port is unavailable, the processing circuitry 130 may attempt to reassign the device to a different available port from the same south die group before considering ports on the north die. This technique may help preserve uniform memory access behavior, power domain consistency, and thermal characteristics, particularly in SoC designs with asymmetric die layouts or multi-region I/O architectures. It may also simplify debugging and system tuning by keeping related peripherals associated with a specific physical segment of the SoC. This approach may introduce a spatial locality bias into the routing logic, favoring port reuse within the same die region to maintain consistent signal path characteristics and avoid latency variation.

In some examples, the processing circuitry 130 may be further configured to activate a first state of a visual indicator associated with the I/O connectors if a high-performance I/O controller port is available and activate a second state of the visual indicator if no high-performance I/O controller port is available. The high-performance I/O controller port may refer to I/O port that offers superior data transfer characteristics compared to the other available ports within the SoC. The performance advantage may result from reduced signal propagation delay, higher bandwidth capability, lower latency, or closer physical or electrical proximity to the system memory. For example, a high-performance I/O controller port may reside on the CPU die and may be characterized by short trace lengths and direct memory access paths, whereas other ports may reside on a separate I/O or platform controller hub (PCH) and may involve longer off-die routing. Such ports may support improved throughput and reduced latency, particularly for bandwidth-sensitive or protocol-sensitive peripheral devices. High-performance I/O controller ports may also support enhanced capabilities such as deterministic data scheduling, lower contention, or reduced power transitions.

The activation of the visual indicator may enable the apparatus 100 to provide real-time, user-facing feedback about the internal routing conditions and the expected I/O performance level available for newly connected peripheral devices. The visual indicator may be implemented as a light-emitting diode (LED), display segment, RGB light strip, icon on a graphical user interface, or any other visual element associated with or adjacent to one or more of the I/O connectors. In some examples, the apparatus 130 may further comprise the visual indicator.

The processing circuitry 130 may evaluate the current availability of I/O controller ports with high performance levels, such as those offering low propagation latency, direct memory proximity, or high-bandwidth protocol support, and based on this evaluation, control the visual indicator accordingly. For example, the first state may be a green LED indicating that a high-performance I/O controller port is available for the next peripheral device to be connected. The second state may be a red or amber LED indicating that only lower-performance ports remain available. This visual feedback mechanism may allow users to make informed connection decisions, especially in systems where peripheral performance is critical. For instance, a user may choose to defer connecting a high-speed storage device if the indicator shows that no high-performance port is currently available. Conversely, a positive indicator may encourage connecting high-bandwidth peripherals at that moment. The technique improves system transparency, enhances user experience, and can prevent accidental performance bottlenecks in dynamic connection environments.

In some examples, there may be a plurality of visual indicators associated with each individual I/O connector, thereby enabling connector-specific feedback that indicates how many high-performance I/O controller ports remain available for use. For instance, each I/O connector may be equipped with its own LED or visual cue, dynamically reflecting whether that particular connector can still be routed to a high-performance port. In other examples, one single shared visual indicator may be provided for the entire group of I/O connectors. This shared indicator may activate a first state, such as a green light, if at least one high-performance I/O controller port is still available, and may switch to a second state, such as a red light, if all high-performance ports are exhausted.

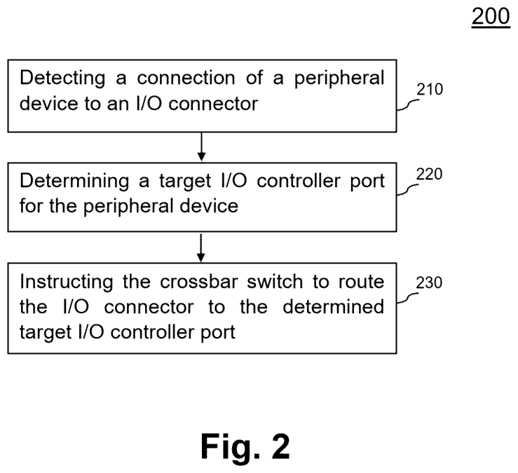

Further details and aspects are mentioned in connection with the examples described below. The example shown in FIG. 1 may include one or more optional additional features corresponding to one or more aspects mentioned in connection with the proposed concept or one or more examples described below (e.g., FIGS. 2-5).

FIG. 2 illustrates a flowchart of an example of a method 200. The method 200 may, for instance, be performed by an apparatus as described herein, such as apparatus 100. The method 200 comprises detecting 210 a connection of a peripheral device to I/O connector of a plurality of I/O connectors connected to a SoC. The plurality of I/O connectors are configured to be coupled to a plurality of I/O controller ports of the SoC via a crossbar switch. The plurality of I/O controller ports are associated with a I/O performance level, wherein at least two of the plurality of I/O controller ports have a different I/O performance level. The method 200 further comprises determining 220 a target I/O controller port from the plurality of I/O controller ports for the peripheral device based on previous routing information for the peripheral device. The method 200 further comprises instructing 230 the crossbar switch to electrically route the I/O connector to the determined target I/O controller port.

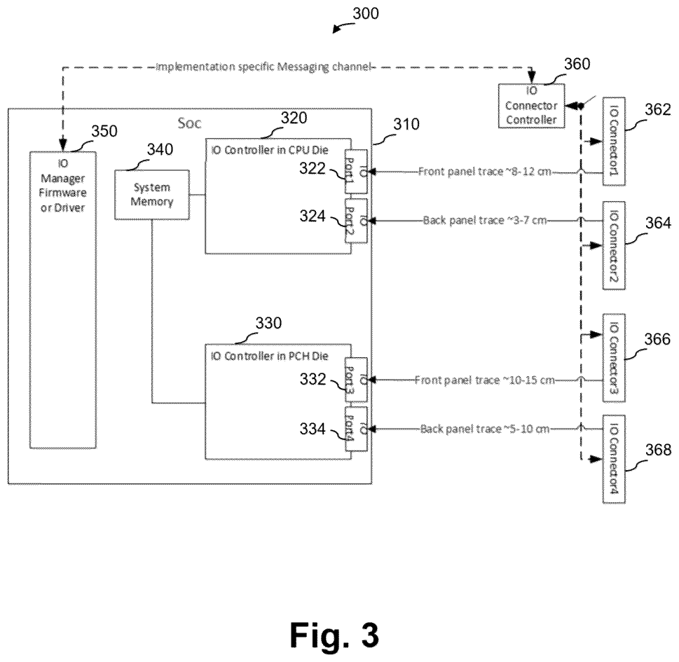

Further details and aspects are mentioned in connection with the examples described above or below. The example shown in FIG. 2 may include one or more optional additional features corresponding to one or more aspects mentioned in connection with the proposed concept or one or more examples described above (e.g., FIG. 1) or below (e.g., FIGS. 3-5).

### FURTHER EXAMPLES

FIG. 3 illustrates an example of a system 300 implementing a static, hardwired mapping of I/O connectors to I/O controller ports in a system on chip (SoC). The system 300 may be a motherboard. The system 300 comprises a SoC 310 that includes a first I/O controller 320 located in a CPU die and a second I/O controller 330 located in a platform controller hub (PCH) die. Each I/O controller 320, 330 is associated with 2 I/O controller ports. The I/O controller 320 in the CPU die comprises a first I/O controller port 322 and a second I/O controller port 324. The I/O controller 330 in the PCH die includes a third I/O controller port 332 and a fourth I/O controller port 334.

Each I/O controller port is connected via a fixed trace to one of four corresponding I/O connectors: a first I/O connector 362, a second I/O connector 364, a third I/O connector 366, and a fourth I/O connector 368. The first I/O connector 362 is coupled to the first port 322 via a front panel trace of approximately 8-12 cm. The second I/O connector 364 is connected to the second port 324 via a back panel trace of approximately 3-7 cm. The third I/O connector 366 is connected to the third port 332 via a front panel trace of approximately 10-15 cm, and the fourth I/O connector 368 is connected to the fourth port 334 via a back panel trace of approximately 5-10 cm.

The SoC 310 further comprises system memory 340 and an I/O manager 350, which may be implemented as firmware or driver logic. The system 300 further includes an I/O connector controller 360, which is connected to the plurality of I/O connectors and is capable of exchanging messages with the SoC 310 over an implementation-specific messaging channel.

Each I/O connector is statically mapped to its dedicated I/O controller port. Because the I/O connectors are hardwired to the I/O ports, port availability cannot be dynamically considered, unused high-performance ports cannot be allocated to new devices if they are not wired to the active connector. Because of this static mapping, the physical trace length from each I/O connector to its corresponding controller port is fixed and non-optimal in many cases, leading to varied signal propagation delays. The performance level of the connection may vary depending on whether the I/O controller resides on the CPU die or the PCH die, due to differences in proximity to system memory and processor cores.

For example, if a peripheral device (such as “device A”) is first connected to I/O connector 364 (mapped to the CPU-side controller port 324), the device may benefit from relatively low latency and high bandwidth. However, if the same device is later connected to I/O connector 366 (mapped to the PCH-side controller port 332), the user may experience degraded performance due to longer trace paths and increased controller distance from the SoC's core components.

FIG. 3 highlights that different I/O ports in the system 300 may have different total trace lengths from the I/O controller to the I/O connector. I/O ports connected to different I/O controllers (for example north die/CPU die vs. south die/PCH die) may have significantly different off-die trace lengths. The varying distances are an important aspect of the physical implementation that may influence the performance level based on signal timing and integrity, particularly at high data rates.

The performance level impact may be modeled by assembling trace length in the system 300 of FIG. 3 as follows:

Trace Length estimates may be as described above:
On-die traces (CPU controller to internal pins): ˜1-5 mm
Motherboard traces (PCH controller to rear panel port): ˜5-10 cm
Motherboard traces (CPU controller to rear panel port): ˜3-7 cm
Motherboard traces (PCH controller to front panel port): ˜10-15 cm
Motherboard traces (CPU controller to front panel port): ˜8-12 cm

Off-die trace lengths may refer to signal paths running outside the SoC 310, for example across the motherboard between the SoC and external I/O connectors 362, 364, 366, 368. On-die trace lengths may refer to internal paths within the SoC 310, such as those between the I/O controllers 320, 330 and other integrated components like processing or memory circuitry 340.

In order to determine the propagation delay the speed of an electrical signal on a PCB trace is assumed to be half to two-thirds the speed of light in a vacuum, that is around: 2×10^8 m/s (as an approximation).

Based on that information the calculations to describe the performance level impact may be determined as follows (determined as Pseudo-code in Perl programming language):

```
<perl code>
#!/usr/bin/perl
use strict;
use warnings;
# Signal speed in m/s
my $speed = 2e8;
# Define each trace path and its length in meters
my %paths = (
  ‘Shortest On-Die Path (CPU-USB1)’ => 5e−3,
  ‘Longest Off-Die Path (PCH-USB2)’ => 0.15,
  ‘Moderate Off-Die Path (PCH-USB1)’ => 0.075,
  ‘Moderate Off-Die Path (CPU-USB2)’ => 0.05,
  ‘Longer Off-Die Path (CPU-USB1)’ => 0.1,
);
print “Propagation Delay Calculations:\n”;
foreach my $desc (sort keys %paths) {
  my $distance = $paths{$desc};
  my $time_s = $distance / $speed;
  my $time_ps = $time_s * 1e12; # Convert seconds to picoseconds
  printf(“%s: %.2f picoseconds\n”, $desc, $time_ps);
}
</perl code>
```

This yields the following results for the relative signal propagation latency (performance level impact) due to the different path length:
Longest Off-Die Path (PCH front panel port): 750.00 picoseconds
Longer Off-Die Path (CPU/front panel port): 500.00 picoseconds
Moderate Off-Die Path (CPU/rear panel port): 250.00 picoseconds
Moderate Off-Die Path (PCH/rear panel port): 375.00 picoseconds
Shortest On-Die Path (CPU/rear panel port): 25.00 picoseconds

This shows a significant performance level hit when utilizing different off-die paths.

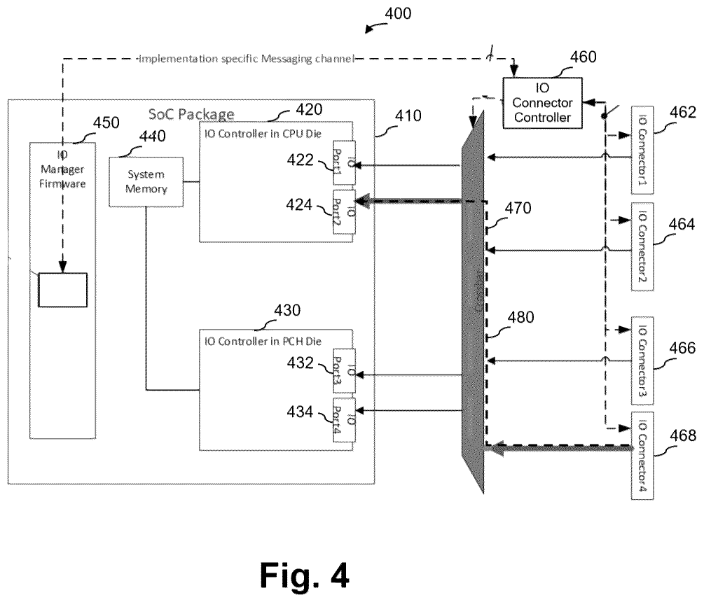

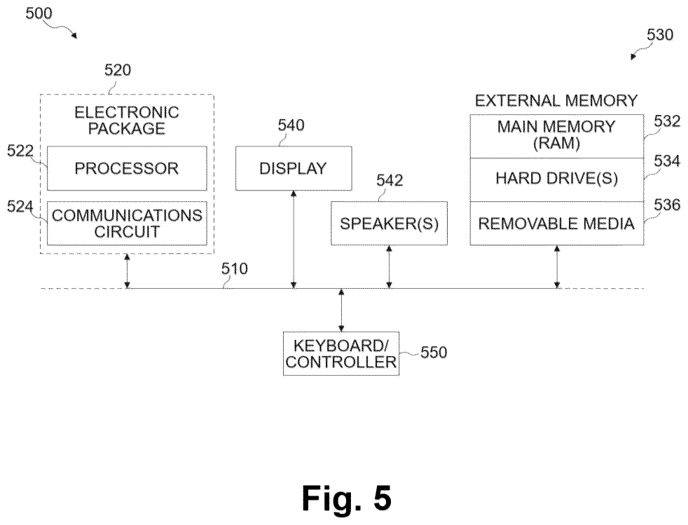

Further details and aspects are mentioned in connection with the examples described above or below. The example shown in FIG. 3 may include one or more optional additional features corresponding to one or more aspects mentioned in connection with the proposed concept or one or more examples described above (e.g., FIGS. 1 to 2) or below (e.g., FIGS. 4-5).

FIG. 4 illustrates an example of a system 400 implementing of the disclosed technique, with flexibility in the mapping of I/O connectors to available I/O controller ports. The system 400 may be a motherboard. The system 400 comprises a system-on-chip (SoC) 410 including a CPU die and a PCH die, a crossbar 470, an I/O connector controller 460, and a plurality of I/O connectors 462, 464, 466, 468. The SoC package 410 further includes a first I/O controller 420 located in the CPU die, and a second I/O controller 430 located in the PCH die. Each controller 420, 430 exposes two I/O controller ports 422, 424 and 432, 434, respectively. The system memory 440 is coupled to both controllers via internal interconnects. The SoC further comprises an I/O manager 450.

In contrast to other systems where each I/O connector may be statically hardwired to a fixed I/O controller port, the technique disclosed in of FIG. 4 comprises a reconfigurable crossbar 470 that enables dynamic routing of any I/O connector to any of the available I/O controller ports. This crossbar 470 may be controlled by the I/O connector controller 460, which includes new logic for selecting and programming the appropriate routing based on platform state and performance goals. As a result, each I/O connector may be routed via the crossbar to an I/O controller port that gives best performance or retains mapping from previous connections. The dashed arrow 480 illustrate an example routing path of such a connection.

The I/O connector 4 (468) is located on the back panel of the system. In other configurations, it might be routed to the I/O controller 430 in the PCH die, resulting in a trace length of approximately 5-10 cm and greater distance from system memory. However, in the example shown, the connector 468 is dynamically routed to I/O port 424 of the CPU die controller 420, which is both physically closer to system memory and connected via a shorter trace length (˜3-7 cm), resulting in reduced latency. Thus, because the I/O connectors can be routed by the crossbar switch 470 programming to the I/O ports of the I/O controllers which are in the CPU die if available, the peripheral device connection can have a closer vicinity to the system memory and hence reduced latency. Because the I/O connectors are routed by the crossbar programming to the I/O ports of the I/O controller, the trace lengths of the I/O connector can be mapped to the I/O ports in the I/O controller with smaller trace lengths and reduced latency.

The system 400 supports an intelligent mapping mechanism that uses I/O manager 450 to cache the I/O controller port mapping for a connected I/O peripheral device. This new logic may also maintain the knowledge of sequence of I/O devices connected by the user and their allocation to different I/O controller ports. This information is used to direct the mapping of these I/O devices connected to I/O connectors to the I/O ports which provide similar performance as previous connections. To facilitate this operation, new messaging from the

I/O manager 450 (driver or firmware) to the I/O port connector controller 460 (firmware) provides a hint regarding the routing of the I/O connection of the I/O device. This message includes platform port ID (port on the I/O controller to which an I/O connector was routed to), peripheral device ID if applicable, and peripheral device type.

The I/O connector controller 460 is configured to interpret such messages and program the routing configuration of the crossbar 470 accordingly. The crossbar switch 470 comprises circuitry configured to support dynamic routing of the I/O connection to the I/O ports in the I/O controller which were used in previous connections. The I/O connector controller 460 programs the crossbar switch to establish a performance I/O connection.

In some examples, the system 400 may implement additional usability features. For example, to mitigate user confusion in scenarios where a desired I/O port is no longer available, a simple implementation may include a visual indicator (e.g., an LED) associated with the I/O connector. The I/O connector controller 460 may activate the indicator to signal whether the I/O connector could be connected to a high-performance port (e.g., dark blue LED) or to a low-performance port (e.g., light blue LED).

This technique 4 thereby demonstrates an intelligent, flexible, and performance-optimized I/O routing architecture using a crossbar and smart control, which overcomes the drawbacks of fixed trace mappings and enables deterministic and consistent performance for peripheral devices, even across repeated connections.

Further details and aspects are mentioned in connection with the examples described above or below. The example shown in FIG. 4 may include one or more optional additional features corresponding to one or more aspects mentioned in connection with the proposed concept or one or more examples described above (e.g., FIGS. 1 to 3) or below (e.g., FIG. 5).

FIG. 5 illustrates an example of a block diagram of an electronic apparatus 500 incorporating at least one electronic assembly 100 and/or method 200 described herein. Electronic apparatus 500 is merely one example of an electronic apparatus in which forms of the electronic assemblies 100 and/or methods 200 described herein may be used. Examples of an electronic apparatus 500 include, but are not limited to, personal computers, tablet computers, mobile telephones, game devices, MP3 or other digital music players, etc. In this example, electronic apparatus 500 comprises a data processing system that includes a system bus 510 to couple the various components of the electronic apparatus 500. System bus 510 provides communications links among the various components of the electronic apparatus 500 and may be implemented as a single bus, as a combination of busses, or in any other suitable manner.

An electronic assembly 520 as describe herein may be coupled to system bus 510. The electronic assembly 520 may include any circuit or combination of circuits. In one embodiment, the electronic assembly 520 includes a processor 522 which can be of any type. As used herein, “processor” means any type of computational circuit, such as but not limited to a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), multiple core processor, or any other type of processor or processing circuit.

Other types of circuits that may be included in electronic assembly 520 are a custom circuit, an application-specific integrated circuit (ASIC), or the like, such as, for example, one or more circuits (such as a communications circuit 524) for use in wireless devices like mobile telephones, tablet computers, laptop computers, two-way radios, and similar electronic systems. The IC can perform any other type of function.

The electronic apparatus 500 may also include an (external) memory 530, which in turn may include one or more memory elements suitable to the particular application, such as a main memory 532 in the form of random access memory (RAM), one or more hard drives 534, and/or one or more drives that handle removable media 536 such as compact disks (CD), flash memory cards, digital video disk (DVD), and the like.

The electronic apparatus 500 may also include a display device 540, one or more speakers 542, and a keyboard and/or controller 550, which can include a mouse, trackball, touch screen, voice—recognition device, or any other device that permits a system user to input information into and receive information from the electronic apparatus 500.

Further details and aspects are mentioned in connection with the examples described above. The example shown in FIG. 5 may include one or more optional additional features corresponding to one or more aspects mentioned in connection with the proposed concept or one or more examples described above (e.g., FIGS. 1-4).

In the following, some examples of the proposed technique are presented:

An example (e.g., example 1) relates to an apparatus comprising interface circuitry, machine-readable instructions and processing circuitry to execute the machine-readable instructions to detect a connection of a peripheral device to an input/output, I/O, connector of a plurality of I/O connectors connected to a system on chip, SoC, wherein the plurality of I/O connectors are configured to be coupled to a plurality of I/O controller ports of the SoC via a crossbar switch, wherein the plurality of I/O controller ports are associated with a I/O performance level, wherein at least two of the plurality of I/O controller ports have a different I/O performance level, determine a target I/O controller port from the plurality of I/O controller ports for the peripheral device based on previous routing information for the peripheral device, and instruct the crossbar switch to electrically route the I/O connector to the determined target I/O controller port.

Another example (e.g., example 2) relates to a previous example (e.g., example 1) or to any other example, further comprising that the processing circuitry is further to execute the machine-readable instructions to determine the target I/O controller port by selecting an available port with the best I/O performance level if no previous routing information for the peripheral device is available.

Another example (e.g., example 3) relates to a previous example (e.g., one of the examples 1 to 2) or to any other example, further comprising that the processing circuitry is further to execute the machine-readable instructions to store the routing information between the peripheral device and the determined target port upon a first connection of the peripheral device.

Another example (e.g., example 4) relates to a previous example (e.g., one of the examples 1 to 3) or to any other example, further comprising that the processing circuitry is further configured to execute the machine-readable instructions to receive a message by an I/O connector controller, the I/O connector controller being connected to the plurality of I/O connectors, wherein the message comprise information that the connection of the peripheral device to the I/O connector is detected.

Another example (e.g., example 5) relates to a previous example (e.g., one of the examples 1 to 4) or to any other example, further comprising that the processing circuitry is further configured to execute the machine-readable instructions to transmit a message to an I/O connector controller, the I/O connector controller being configured to program the crossbar switch, wherein the message comprising information regarding the routing of the I/O connector to the determined target I/O controller port.

Another example (e.g., example 6) relates to a previous example (e.g., example 5) or to any other example, further comprising that the message comprises at least one of a target I/O port identifier, a peripheral device identifier, or a peripheral device type.

Another example (e.g., example 7) relates to a previous example (e.g., one of the examples 1 to 6) or to any other example, further comprising that the I/O performance level comprises a signal propagation latency between the I/O connector and a memory of the SoC, and a higher I/O performance level corresponds to a lower propagation latency

Another example (e.g., example 8) relates to a previous example (e.g., example 7) or to any other example, further comprising that the signal propagation latency is based on at least one of the following a physical trace length of a signal path between the I/O connector and the I/O controller port, a distance between the I/O controller and a memory of the SoC or a location of the I/O controller, wherein the location of the I/O controller is either on a north die or a south die of the SoC.

Another example (e.g., example 9) relates to a previous example (e.g., one of the examples 1 to 8) or to any other example, further comprising that the processing circuitry is further to execute the machine-readable instructions to observe performance characteristics of the peripheral device via port telemetry.

Another example (e.g., example 10) relates to a previous example (e.g., example 9) or to any other example, further comprising that the processing circuitry is further to execute the machine-readable instructions to determine, based on the observed performance characteristics, that a peripheral device's performance requirement is met by a lower-performance I/O controller port, and update the stored routing information for the peripheral device, wherein the lower-performance I/O controller port is stored as the updated target port.

Another example (e.g., example 11) relates to a previous example (e.g., one of the examples 1 to 10) or to any other example, further comprising that the processing circuitry is further to execute the machine-readable instructions to determine the target I/O controller port by selecting an available port with a next highest I/O performance level if the I/O controller port used in a previous connection is not available.

Another example (e.g., example 12) relates to a previous example (e.g., one of the examples 1 to 11) or to any other example, further comprising that determining the target I/O controller port is based on an order in which a plurality of different peripheral devices are connected to the SoC, the order establishing a routing preference for subsequent connections of the peripheral devices.

Another example (e.g., example 13) relates to a previous example (e.g., one of the examples 1 to 12) or to any other example, further comprising that a first group of the I/O controller ports is located on a north die of the Soc and a second group is located on south die of the SoC, and wherein the target I/O controller port is determined by selecting a I/O controller port from the same group that was used for a previous connection.

Another example (e.g., example 14) relates to a previous example (e.g., one of the examples 1 to 13) or to any other example, further comprising that the processing circuitry is further to execute the machine-readable instructions to activate a first state of a visual indicator associated with the I/O connectors if a high-performance I/O controller port is available and activate a second state of the visual indicator if no high-performance I/O controller port is available.

Another example (e.g., example 15) relates to a previous example (e.g., one of the examples 1 to 14) or to any other example, the apparatus further comprising the visual indicator.

Another example (e.g., example 16) relates to a previous example (e.g., one of the examples 1 to 15) or to any other example, the apparatus further comprising the SoC.

Another example (e.g., example 17) relates to a previous example (e.g., one of the examples 1 to 16) or to any other example, the apparatus further comprising the crossbar switch.

Another example (e.g., example 18) relates to a previous example (e.g., one of the examples 1 to 17) or to any other example, the apparatus further comprising the plurality of I/O connectors.

An example (e.g., example 19) relates to a method comprising detecting a connection of a peripheral device to an input/output, I/O, connector of a plurality of I/O connectors connected to a system on chip, SoC, wherein the plurality of I/O connectors are configured to be coupled to a plurality of I/O controller ports of the SoC via a crossbar switch, wherein the plurality of I/O controller ports are associated with a I/O performance level, wherein at least two of the plurality of I/O controller ports have a different I/O performance level, determining a target I/O controller port from the plurality of I/O controller ports for the peripheral device based on previous routing information for the peripheral device, and instructing the crossbar switch to electrically route the I/O connector to the determined target I/O controller port.

Another example (e.g., example 20) relates to a previous example (e.g., example 19) or to any other example, further comprising determining the target I/O controller port by selecting an available port with the best I/O performance level if no previous routing information for the peripheral device is available.

Another example (e.g., example 21) relates to a previous example (e.g., one of the examples 19 to 20) or to any other example, further comprising storing the routing information between the peripheral device and the determined target port upon a first connection of the peripheral device.

Another example (e.g., example 22) relates to a previous example (e.g., one of the examples 19 to 21) or to any other example, further comprising receiving a message by an I/O connector controller, the I/O connector controller being connected to the plurality of I/O connectors, wherein the message comprise information that the connection of the peripheral device to the I/O connector is detected.

Another example (e.g., example 23) relates to a previous example (e.g., one of the examples 19 to 23) or to any other example, further comprising transmitting a message to an I/O connector controller, the I/O connector controller being configured to program the crossbar switch, wherein the message comprising information regarding the routing of the I/O connector to the determined target I/O controller port.

Another example (e.g., example 24) relates to a previous example (e.g., example 23) or to any other example, further comprising that the message comprises at least one of a target I/O port identifier, a peripheral device identifier, or a peripheral device type.

Another example (e.g., example 25) relates to a previous example (e.g., one of the examples 19 to 24) or to any other example, further comprising that the I/O performance level comprises a signal propagation latency between the I/O connector and a memory of the SoC, and a higher I/O performance level corresponds to a lower propagation latency

Another example (e.g., example 26) relates to a previous example (e.g., example 25) or to any other example, further comprising that the signal propagation latency is based on at least one of the following a physical trace length of a signal path between the I/O connector and the I/O controller port, a distance between the I/O controller and a memory of the SoC or a location of the I/O controller, wherein the location of the I/O controller is either on a north die or a south die of the SoC.

Another example (e.g., example 27) relates to a previous example (e.g., one of the examples 19 to 26) or to any other example, further comprising observing performance characteristics of the peripheral device via port telemetry.

Another example (e.g., example 28) relates to a previous example (e.g., example 27) or to any other example, further comprising determining, based on the observed performance characteristics, that a peripheral device's performance requirement is met by a lower-performance I/O controller port, and updating the stored routing information for the peripheral device, wherein the lower-performance I/O controller port is stored as the updated target port.

Another example (e.g., example 29) relates to a previous example (e.g., one of the examples 19 to 28) or to any other example, further comprising determining the target I/O controller port by selecting an available port with a next highest I/O performance level if the I/O controller port used in a previous connection is not available.

Another example (e.g., example 30) relates to a previous example (e.g., one of the examples 19 to 29) or to any other example, further comprising that determining the target I/O controller port is based on an order in which a plurality of different peripheral devices are connected to the SoC, the order establishing a routing preference for subsequent connections of the peripheral devices.

Another example (e.g., example 31) relates to a previous example (e.g., one of the examples 19 to 30) or to any other example, further comprising that a first group of the I/O controller ports is located on a north die of the Soc and a second group is located on south die of the SoC, and wherein the target I/O controller port is determined by selecting a I/O controller port from the same group that was used for a previous connection.

Another example (e.g., example 32) relates to a previous example (e.g., one of the examples 19 to 31) or to any other example, further comprising activating a first state of a visual indicator associated with the I/O connectors if a high-performance I/O controller port is available and activate a second state of the visual indicator if no high-performance I/O controller port is available.

Another example (e.g., example 33) relates to a non-transitory computer-readable medium storing instructions that, when executed by one or more processing circuitries, causing the one or more processing circuitries to perform the method of any one of examples 19 to 32.

An example (e.g., example 34) relates to an apparatus comprising a processor circuitry configured to detect a connection of a peripheral device to an input/output, I/O, connector of a plurality of I/O connectors connected to a system on chip, SoC, wherein the plurality of I/O connectors are configured to be coupled to a plurality of I/O controller ports of the SoC via a crossbar switch, wherein the plurality of I/O controller ports are associated with a I/O performance level, wherein at least two of the plurality of I/O controller ports have a different I/O performance level, determine a target I/O controller port from the plurality of I/O controller ports for the peripheral device based on previous routing information for the peripheral device, and instruct the crossbar switch to electrically route the I/O connector to the determined target I/O controller port.

An example (e.g., example 35) relates to a device comprising means for processing for detecting a connection of a peripheral device to an input/output, I/O, connector of a plurality of I/O connectors connected to a system on chip, SoC, wherein the plurality of I/O connectors are configured to be coupled to a plurality of I/O controller ports of the SoC via a crossbar switch, wherein the plurality of I/O controller ports are associated with a I/O performance level, wherein at least two of the plurality of I/O controller ports have a different I/O performance level, determining a target I/O controller port from the plurality of I/O controller ports for the peripheral device based on previous routing information for the peripheral device, and instructing the crossbar switch to electrically route the I/O connector to the determined target I/O controller port.

Another example (e.g., example 36) relates to a computer program having a program code for performing the method of any one of examples 19 to 32 when the computer program is executed on a computer, a processor, or a programmable hardware component.

Another example (e.g., example 37) relates machine-readable storage including machine readable instructions, when executed, to implement a method or realize an apparatus as claimed in any pending example.

Another example (e.g., example 38) relates to a computer-readable medium including program code, when executed, to cause a machine to perform the method of any one of examples 19 to 32.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor-or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps,-functions,-processes or-operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus comprising interface circuitry, machine-readable instructions and processing circuitry to execute the machine-readable instructions to:
detect a connection of a peripheral device to an input/output, I/O, connector of a plurality of I/O connectors connected to a system on chip, SoC,
wherein the plurality of I/O connectors are configured to be coupled to a plurality of I/O controller ports of the SoC via a crossbar switch,
wherein the plurality of I/O controller ports are associated with a I/O performance level, wherein at least two of the plurality of I/O controller ports have a different I/O performance level;
determine a target I/O controller port from the plurality of I/O controller ports for the peripheral device based on previous routing information for the peripheral device; and
instruct the crossbar switch to electrically route the I/O connector to the determined target I/O controller port.

2. The apparatus of claim 1, wherein the processing circuitry is further to execute the machine-readable instructions to determine the target I/O controller port by selecting an available port with the best I/O performance level if no previous routing information for the peripheral device is available.

3. The apparatus of claim 1, wherein the processing circuitry is further to execute the machine-readable instructions to store the routing information between the peripheral device and the determined target port upon a first connection of the peripheral device.

4. The apparatus of claim 1, wherein the processing circuitry is further configured to execute the machine-readable instructions to receive a message by an I/O connector controller, the I/O connector controller being connected to the plurality of I/O connectors, wherein the message comprise information that the connection of the peripheral device to the I/O connector is detected.

5. The apparatus of claim 1, wherein the processing circuitry is further configured to execute the machine-readable instructions to transmit a message to an I/O connector controller, the I/O connector controller being configured to program the crossbar switch, wherein the message comprising information regarding the routing of the I/O connector to the determined target I/O controller port.

6. The apparatus of claim 5, wherein the message comprises at least one of a target I/O port identifier, a peripheral device identifier, or a peripheral device type.

7. The apparatus of claim 1, wherein the I/O performance level comprises a signal propagation latency between the I/O connector and a memory of the SoC, and a higher I/O performance level corresponds to a lower propagation latency

8. The apparatus of claim 7, wherein the signal propagation latency is based on at least one of the following: a physical trace length of a signal path between the I/O connector and the I/O controller port, a distance between the I/O controller and a memory of the SoC or a location of the I/O controller, wherein the location of the I/O controller is either on a north die or a south die of the SoC.

9. The apparatus of claim 1, wherein the processing circuitry is further to execute the machine-readable instructions to observe performance characteristics of the peripheral device via port telemetry.

10. The apparatus of claim 9, wherein the processing circuitry is further to execute the machine-readable instructions to determine, based on the observed performance characteristics, that a peripheral device's performance requirement is met by a lower-performance I/O controller port; and
update the stored routing information for the peripheral device, wherein the lower-performance I/O controller port is stored as the updated target port.

11. The apparatus of claim 1, wherein the processing circuitry is further to execute the machine-readable instructions to determine the target I/O controller port by selecting an available port with a next highest I/O performance level if the I/O controller port used in a previous connection is not available.

12. The apparatus of claim 1, wherein determining the target I/O controller port is based on an order in which a plurality of different peripheral devices are connected to the SoC, the order establishing a routing preference for subsequent connections of the peripheral devices.

13. The apparatus of claim 1, wherein a first group of the I/O controller ports is located on a north die of the Soc and a second group is located on south die of the SoC, and wherein the target I/O controller port is determined by selecting a I/O controller port from the same group that was used for a previous connection.

14. The apparatus of claim 1, wherein the processing circuitry is further to execute the machine-readable instructions to activate a first state of a visual indicator associated with the I/O connectors if a high-performance I/O controller port is available and activate a second state of the visual indicator if no high-performance I/O controller port is available.

15. The apparatus of claim 1 further comprising the visual indicator.

16. The apparatus of claim 1 further comprising the SoC.

17. The apparatus of claim 1 further comprising the crossbar switch.

18. The apparatus of claim 1 further comprising the plurality of I/O connectors.

19. A method comprising:
detecting a connection of a peripheral device to an input/output, I/O, connector of a plurality of I/O connectors connected to a system on chip, SoC,
wherein the plurality of I/O connectors are configured to be coupled to a plurality of I/O controller ports of the SoC via a crossbar switch,
wherein the plurality of I/O controller ports are associated with a I/O performance level, wherein at least two of the plurality of I/O controller ports have a different I/O performance level;
determining a target I/O controller port from the plurality of I/O controller ports for the peripheral device based on previous routing information for the peripheral device; and
instructing the crossbar switch to electrically route the I/O connector to the determined target I/O controller port.

20. A non-transitory computer-readable medium storing instructions that, when executed by one or more processing circuitries, causing the one or more processing circuitries to perform the method of claim 19.
